(19) United States
(12) Patent Application Publication
(10) Pub. No.: US 2004/0218240 A1
(43) Pub. Date: Nov. 4, 2004

(54) Compact holographic data storage system

(76) Inventors: Chih-Ming Lin, Taichung (TW); Wen-Yih Liao, Taichung (TW); Chuen-Fuw Yan, Kaohsiung (TW)

Correspondence Address: David A. Hall, Heller Ehrman White & McAuliffe LLP, 7th Floor, 4350 La Jolla Village Drive, San Diego, CA, 92122-1246, US

(21) Appl. No.: 10/628,988

(22) Filed: Jul. 28, 2003

(30) Foreign Application Priority Data
Apr. 29, 2003 (TW) 092109968

(51) Int. Cl. G02B 5/32

(52) U.S. Cl. 359/15; 359/12

(57) ABSTRACT

A holographic data storage system having high recording density and compact memory architecture is disclosed. The system includes a laser light source, a spatial light modulator (40) for data input, a beam splitter (50) for separating out part of the parallel laser beams as reference beam, and a beam steering system (60). Parallel laser beams passing through the spatial light modulator (40) form a two-dimensional signal beam carrying digital data. Unique patterns are then generated from interference of the signal beam and the reference beam, which can be recorded into the volume holographic medium (10) with unique incident position ` angle and cross sectional phase distribution of reference beam.

### BACKGROUND OF THE INVENTION

1. Field of the Invention

The present invention relates to a compact holographic data storage system, in particular to a holographic data storage system with high storage density, small size and data-random-accessability.

2. Description of Related Arts

Holographic memory systems have immense potential for the future due to their high capacity for data storage by various kinds of multiplexing recording techniques and fast access time by signal parallel processing technique. There has been extensive research in holographic memory, but it has not been extensively used in consumer oriented data storage media. The main limitation for conventional holographic memory systems is that their sizes too big for installation in consumer-oriented electronic products. Because of the lack of simple optical architecture and a compact light source with high power, the conventional holographic memory systems are hard to be widely used. With the recent advance in the manufacturing technology of solid-state laser diodes, there has been small size, high power and wavelength-changeable commercialized products of them. As for the optical system of holographic memory, some compact designs have been already proposed. Therefore many conventional bottlenecks of holographic recording technique has been gradually overcame with the advance of its related technologies and time passing.

The compact holographic memory system looks even more promising than the popular optical disk memory system in that the holographic memory system does not require media rotation for data retrieval and storage, and does not have to be circular shaped. In general, the holographic medium for a holographic memory system is usually created as a cube shape (approx. 1×1×1 cm³) or a rectangular parallel pipe. Therefore, by using compact optical system design and high power laser diode, holographic memory systems can be produced in sizes even smaller than conventional optical disks.

The block diagram of a holographic data storage system in one prior art patent is shown in FIG. 13. When the system is in recording mode, a laser light source (835) passing through a beam splitter (836) is separated and modulated to become a signal beam (831) and a reference beam for writing in data (820). The above signal beam (831) is further passed through another beam splitter (833) to cause the laser beam to be directed toward an opto-electronic integrated circuit (804).

The detailed diagram of the opto-electronic integrated circuit (804) in FIG. 14 reveals that pixels are arranged thereon in matrix format (806), each pixel containing a modulator (824) and a detector (823). The modulators (824) are used to modulate a signal beam (826) to carry a digital image of the write data into a crystal cube (802). The above modulated signal beam (826) and the reference beam (820) of the write data will cross over each other in the crystal cube (802), and produce an interference pattern, which will then be recorded in the crystal cube (802).

If the system proceeds to record the next digital image, a diffraction element (810) is needed to change the incident angle of the reference beam (820) into the crystal cube (802) to enable another data recording

When the system is in data readout mode, after the laser light source (835) passes through the beam splitter (836), the signal beam (831) will be masked, leaving only the reference beam (820) to be guided through the diffractive component (810) to change the direction of the reference beam (820) and reach a self-pumped phase conjugator (832). The self-pumped phase conjugator (832) then generates a counter propagating reference beam (821) casting onto the crystal cube (802), where a reconstructed beam (825) is generated towards the opto-electronic integrated circuit (804). Each detector (823) matching a respective pixel (806) in the opto-electronic integrated circuit (804) will then read out the digital image stored therein. If the system proceeds to read out the next digital image, the diffractive optical element (810) is needed to change the incident angle of the reference beam into the crystal.

However, the above mentioned prior art patent has several shortcomings:

(1) the opto-electronic integrated circuit (804) is too complicated for commercial production;

(2) the detector (823) and the modulator (824) matching against each pixel (806) cannot be disposed in the same position, therefore a reconstructed beam (825) is required for supplementing the biasing angle; and

(3) the design and architecture of the whole optical system involves high costs in actual implementation.

A holographic optical system with simpler and cost effective architecture can be constructed with the present invention.

### SUMMARY OF THE INVENTION

The main object of the present invention is to provide a holographic memory system with high recording density ` compact size and data random access. The architecture of the holographic memory system in accordance with the present invention includes:

a volume holographic recording medium for storing superimposed interference patterns;

a laser emitting assembly having a large output area for emission of parallel laser beams with different wavelength and proper cross sectional shape;

a beam splitter being disposed in the optical path of the parallel beams for separating out a portion of the parallel beams to generate a reference beam;

a beam steering system for steering the separated reference beam, such that the reference beam can be directed to predetermined positions on a volume holographic recording medium with proper incident angles;

a phase modulator being disposed in the optical path of the reference beam for generating beams with different cross-sectional phase distribution patterns; and

a spatial light modulator as two-dimensional grating format being disposed in the optical path of the parallel beams for holographic data input;

a photo detector as two dimensional grating format for detecting the reconstructed signal after the reference beam is propagated to the volume holographic recording medium, during data read from the volume holographic recording medium.

The features and structure of the present invention will be more clearly understood when taken in conjunction with the accompanying drawings.

### BRIEF DESCRIPTION OF THE DRAWINGS

FIG. 1 is the system architecture of the present invention;

FIGS. 2, 3 are the schematic diagrams showing the holographic signal input/output paths in accordance with the first embodiment of the invention;

FIGS. 4, 5 are the schematic diagrams showing the holographic signal input/output paths in accordance with the second embodiment of the invention;

FIGS. 6, 7 are the schematic diagrams showing the holographic signal input/output paths incorporating a phase modulator in the third embodiment of the invention;

FIG. 8 is a diagram of a spatial phase modulator made from transmissive type LCD in the path of reference beam;

FIG. 9 shows the use of several laser diodes as light source with different wavelength selectively feeding through a cylindrical collimator;

FIG. 10 shows a spatial multiplexing recording by only changing the f reference beam incident position into recording medium;

FIG. 11 shows a angle multiplexing recording by only changing the reference beam incident angle into recording medium;

FIG. 12 shows a beam splitter for reference beam in accordance with one embodiment of the invention;

FIG. 13 is the structural diagram of a conventional holographic memory system;

FIG. 14 is a diagram of an opto-electronic integrated circuit revealing detailed architecture of the pixel array.

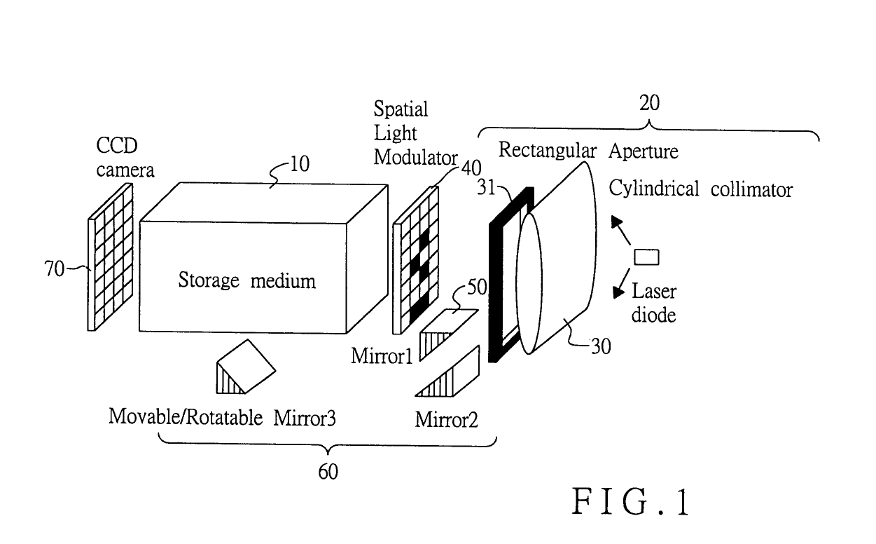

### DETAILED DESCRIPTION OF THE PREFERRED EMBODIMENT

The present invention provides a holographic memory system comprising:

a volume holographic recording medium (10) that can be used to store superimposed holographic interference patterns, and the material used on the diffractive crystals can be LiNbO₃:Fe, BaTiO₃, or other organic photo-sensitive materials;

a laser emitting assembly (20) for emitting diverging laser beams through a cylindrical collimated lens (30) and a rectangular aperture (31) becoming parallel beams with different wavelength and cross sectional phase distribution;

a beam splitter (50) disposed in the optical beam path for separating out a portion of the parallel beams;

a beam steering system (60) for steering the reference beam output from the beam splitter (50), such that the reference beam can be modulated to the volume holographic recording medium (10) with proper tuning of the mirror position and reflective angle;

a phase modulator (61) being disposed in the optical path of the reference beam for generating a different cross sectional phase distribution; and

a spatial light modulator (40) represented by two-dimensional grating format for data input into the volume holographic recording medium (10);

a photo detectors (70) in grating format for reading out data from the volume holographic recording medium (10), such that each detector (70) is able to sense the presence of a regenerated signal after the reference beam enters the volume holographic recording medium (10).

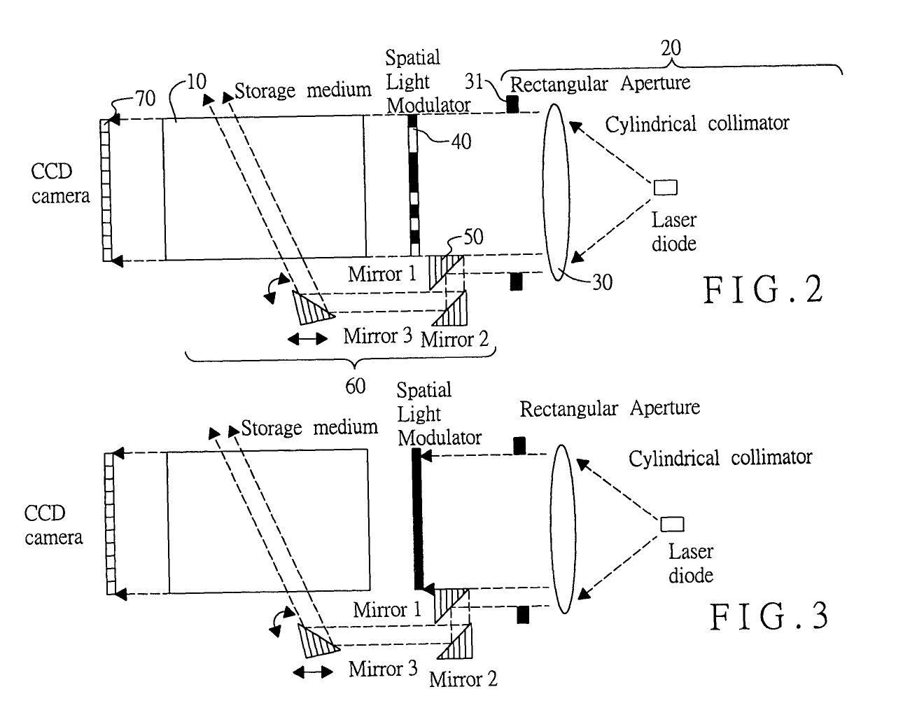

FIG. 2 shows data entering the holographic memory system for data write to the volume holographic recording medium (10). Two coherent beams enter the volume holographic recording medium (10) and cross over each other to produce a three-dimensional interference pattern which is then imparted on the volume holographic recording medium (10) with a particular wavelength. When writing in data, the laser emitting assembly (20) provides a parallel laser beam with proper wavelength and cross sectional phase profile. A beam splitter (50) disposed in the optical path of the reference beam intercepts a portion of the parallel beams to produce a write reference beam. In the current implementation the beam splitter (50) is implemented by a first reflective mirror (mirror1), which intercepts the parallel beams to enter the beam steering system (60) formed by the second reflective mirror (mirror2) and the third reflective mirror (mirror3).

The remaining portion of the parallel beams passes through the spatial light modulator (40). In the current embodiment the modulators (40) in grating format are implemented by a transmissive LCD panel serving as the holographic input apparatus. The parallel beams pass through the transmissive LCD panel and becomes an objective signal beam then cast onto the volume holographic recording medium (10). The write reference beam emitted from the beam steering system (60) enters the volume holographic recording medium (10) with a proper incident angle and fincident position to proceed with the spatial and angular multiplexing recording. Each incident position and angle of the incident beam is matched against a respective particular data page in the volume holographic recording medium (10).

The above mentioned write reference beam and signal beam will interfere with each other in the volume holographic recording medium (10), and the interference of two beams will produce a unique spatial pattern in accordance with the electromagnetic intensity imparted on the volume holographic recording medium (10). The spatial interference pattern will be stored in the volume holographic recording medium (10). If there is another page of data to be recorded, the data will be input in like manner through the transmissive LCD panel. Selecting a different incident angle and position of reference beam, the second page of data will be successfully recorded in the volume holographic recording medium (10).

FIG. 3 shows data read out path from the volume holographic recording medium (10). The LCD panel will be completely covered to shut off all light beams. At the same time the incident angle and position of reference beam corresponding to the data page in the volume holographic recording medium (10) are selected to guide the reference beam to a particular data page in the volume holographic recording medium (10). When the read reference beam touches the interference pattern corresponding to the selected data page, a diffraction beam, the reconstruction of signal beam, will be produced, and the diffraction beam will be projected towards a photo detector (70), which is implemented by a charge couple detector (CCD) camera in the current embodiment, such that the CCD camera will be able to retrieve the data from a selected position of the volume holographic recording medium (10). It is preferred that the pixel positions and number of pixels on the CCD camera should be able to match against the corresponding pixel positions and total number of pixels on the LCD panel.

The relative positions of the first reflective minor (mirror1) and the second reflective mirror (mirror2) can be adjusted to suit the thickness of the beam slices. It should be noted that the first reflective mirror (mirror1) should not enter the lower portion of the spatial light modulator (40) to avoid cutting off the parallel beams passing through the LCD panel. The third reflective mirror (mirror3) is movable or rotatable to adjust the horizontal position and reflective angle for propagating the reference beam to the predetermined incident position with proper incident angle. When the system records data on different pages, the write reference beam should be directed to proper mirror positions and reflective angles. This is a combinational approach from the spatial multiplexing and angular multiplexing techniques conventionally used for a holographic recording medium.

The above mentioned spatial light modulator (40) are implemented by a transmissive LCD panel in the preferred embodiment. The on/off status of all pixels on the LCD panel represents a data page on a two-dimensional plane. When the parallel beams derived from the laser emitting assembly (20) pass through the transmissive LCD panel, a grating pattern composing of light gating components is created thus becoming the signal beam, which then enters the volume holographic recording medium (10) for data recording. When the system reads out data as shown in FIG. 3, all pixels on the LCD panel are covered to cut off all light.

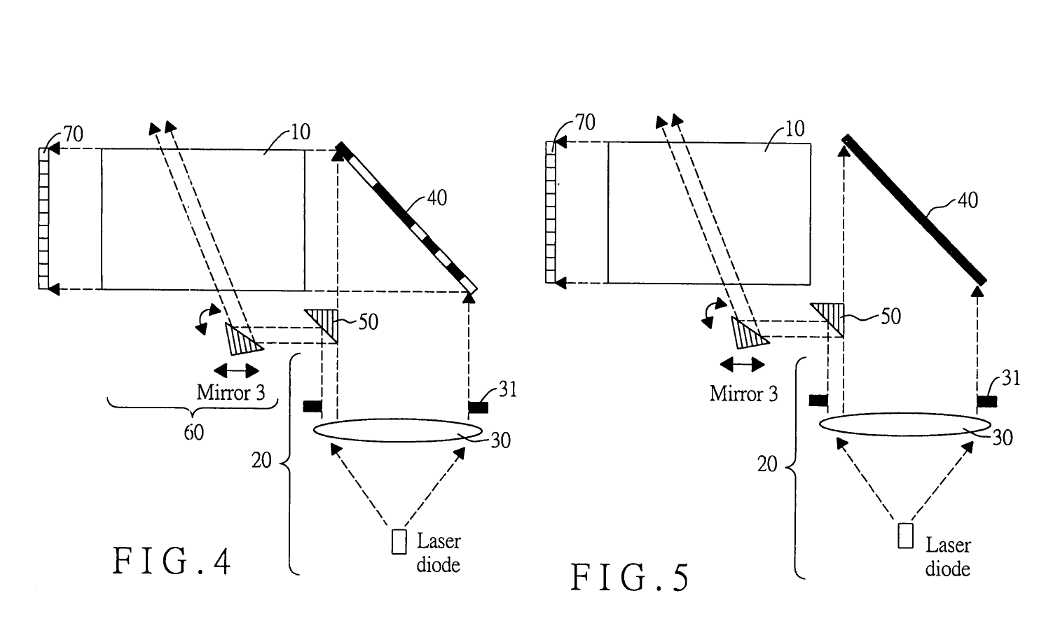

The second embodiment of the invention is shown in FIGS. 4, 5. The basic operating principles are similar to those shown in FIGS. 2, 3, except that a reflective LCD panel is employed as the spatial light modulator (40) instead of the transmissive LCD panel with proper set up of the first reflective mirror (mirror1), that means the second reflective mirror (mirror2) is not necessary in the present configuration.

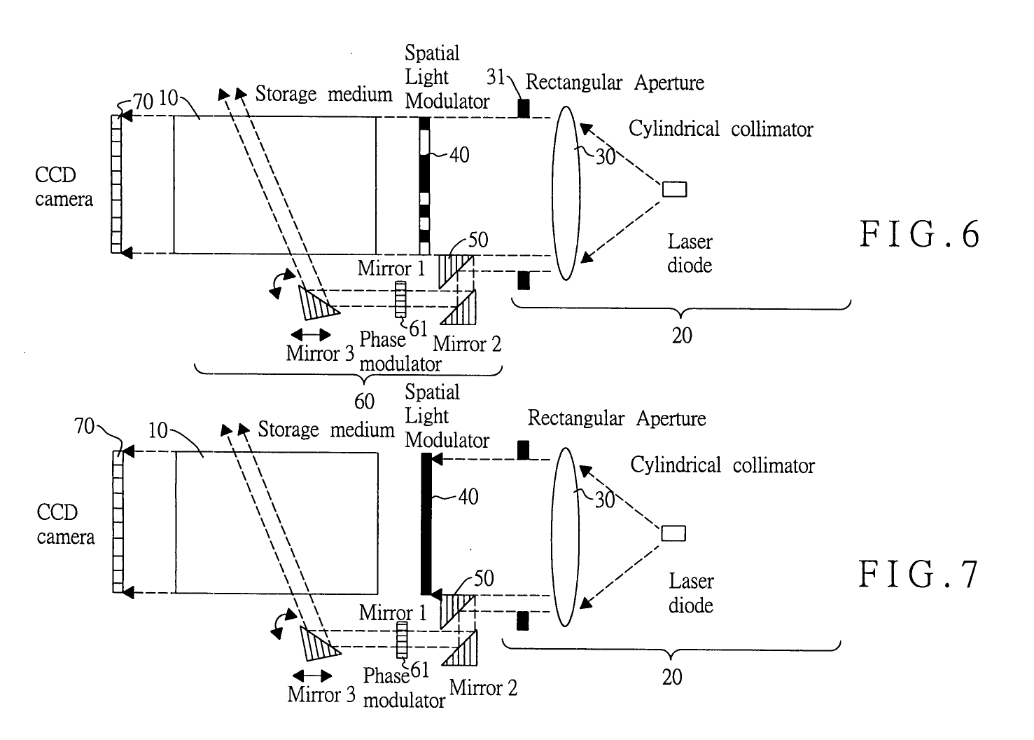

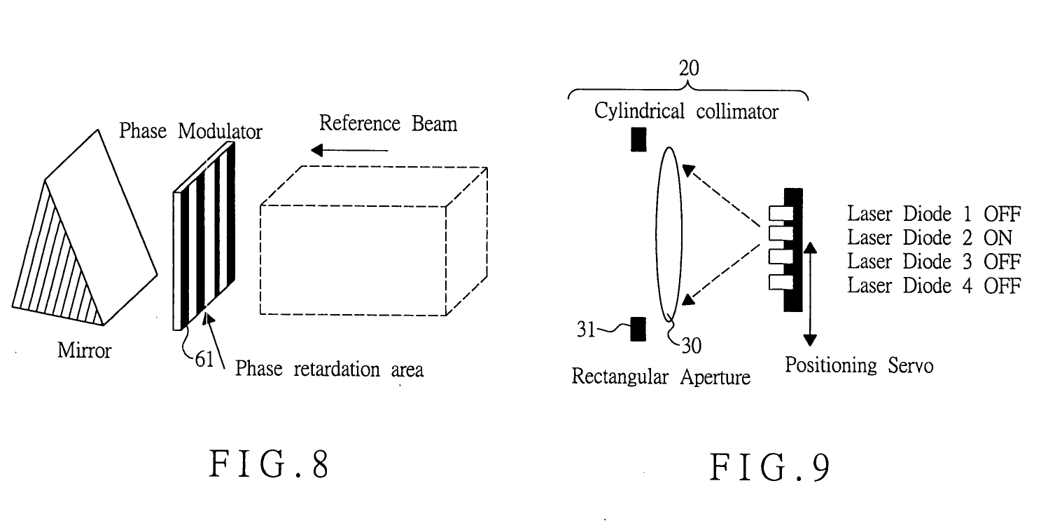

A modified version of the first implementation using phase code multiplexing is shown in FIGS. 6 7. A phase modulator (61) is disposed in the optical path of the reference beam in the beam steering system (60) to enable the production of different cross sectional phase distribution of the reference beam, such that a reference beam having a particular cross sectional phase distribution, mirror position and reflective angle can be used for writing data to or reading out data from a particular page of the volume holographic recording medium. In this embodiment, the phase code multiplexing recording is introduced. The phase modulator (61) is implemented by a fully transmissive LCD panel as shown in FIG. 8. The phase modulator (61) is able to produce different phase delays for parallel beams passing through the beam steering system (60) from different positions. In the current embodiment, the phase delay pattern is in the form of long streaks. The beams passing through the same streak will possess the same phase delay characteristics. The longer side of the streaked parallel pipe is parallel to the longer side of the long and narrow cross-section of the reference beam in the beam steering system (60).

Another implementation of the invention with wavelength multiplexing is shown in FIG. 9. The wavelength of the laser beam from the laser emitting assembly (20) can be changed selectively. The laser emitting assembly (20) may be implemented with a laser diode with variable wavelength or a group of laser diodes with different wavelength (the example used in FIG. 4 has four laser diodes). When the light source is composed of multiple laser diodes with different wavelength, a servo system is required to select a laser diode having the selected wavelength which is then fixed in the center position of the focus area of the cylindrical collimated lens. When the light passes through the cylindrical collimated lens and the rectangular aperture, parallel laser beams with proper cross sectional shape and wavelength are generated to proceed with the wavelength multiplexing recording. A reference beam having a particular cross sectional phase distribution and particular incident position and angle is able to control write data to or read data from a predetermined page of the volume holographic recording medium.

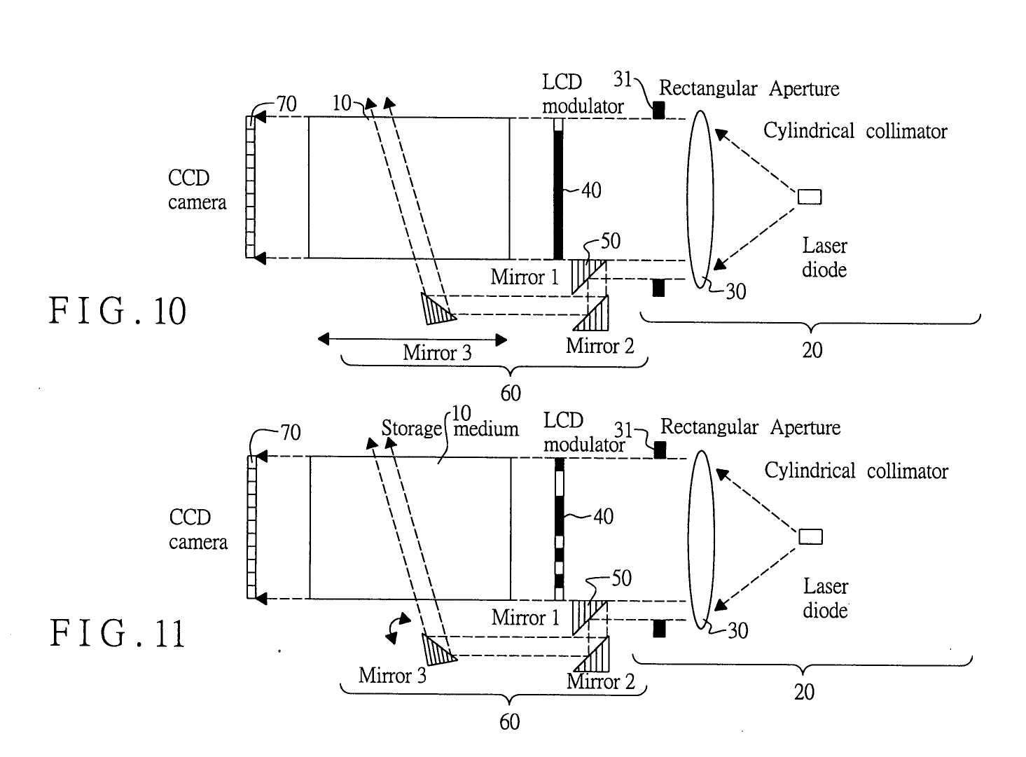

Besides, for a simple and cost effective system design, certain multiplexing functions may have to be sacrificed. In one case, the system employs a single wavelength laser diode as the light source to simplify the servo mechanism of the holographic memory system. In another case, the system, as shown in FIG. 10, by sacrificing the benefits of angular multiplexing, the beam steering system (60) employs the adjustment of mirror position to modulate the reference beam, whilst keeping with a fixed light reflective angle; or else, the system, as shown in FIG. 11, may also be modified to only allow changes in reflective angle but keeping with a fixed mirror position, thus sacrificing the benefits of spatial multiplexing. If the system does or not use phase modulator (61) for the reference beam, it has sacrificed phase code multiplexing.

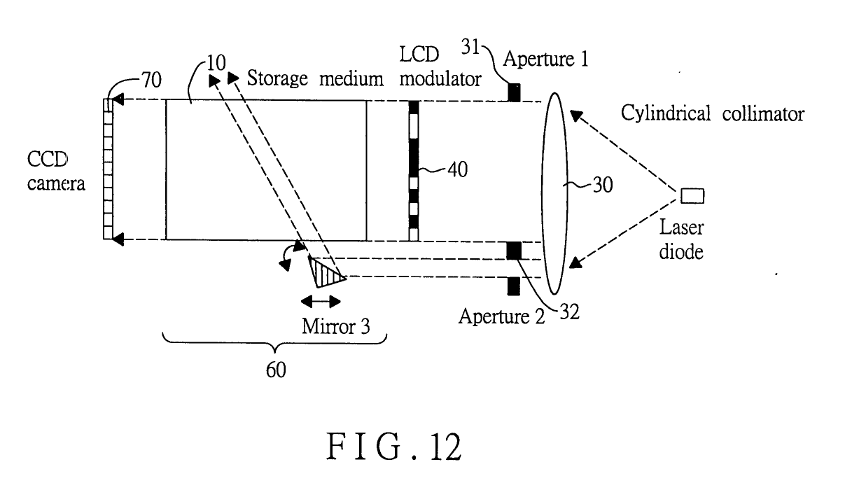

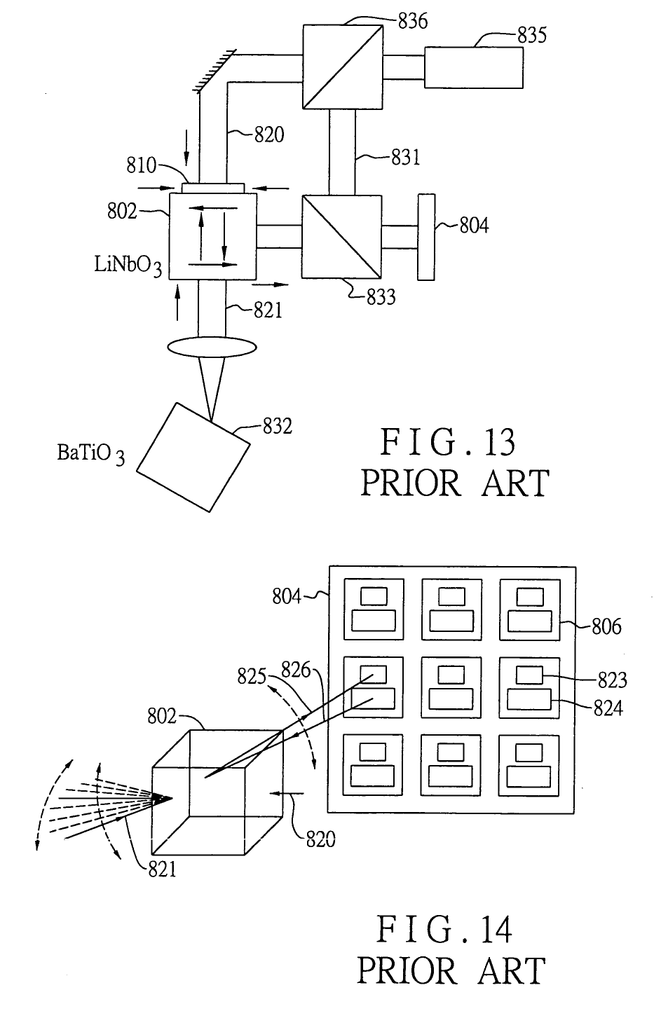

An implementation of a beam splitter for reference beam is shown in FIG. 12, in which the laser beams are routed through a cylindrical collimated lens, and further through a square aperture (31) and a narrow rectangular aperture (32), to reach a spatial light modulator (40), and the parallel laser beams are routed through the rectangular aperture (32) to enter the beam steering system (60). Under the above architecture, the first and second reflective mirrors (mirror1 and mirror2) are not required.

In the beam steering system (60) mentioned above, the system includes several reflective mirrors controlled by a servo motor used for controlling the mirror position and reflective angle. Using this means to modulate the reference beam to the holographic medium, the spatial multiplexing recording and angular multiplexing recording can thus be performed. When a phase modulator (61) is disposed in the optical path of the beam steering system (60), a different cross sectional phase distribution of the reference beam can be produced for the phase code multiplexing recording.

To avoid the use of any mechanical means for adjusting the mirror position and reflective angle, an opto-electronic beam steering device can be employed in the beam steering system (60) to change the incident position and angle of the reference beam without djustment of mirror position and angle.

It will be appreciated that a compact holographic recording system using the above mentioned multiplexing recording techniques or a combination thereof can be constructed by any person with ordinary skill in the art, without departing from the scope of the invention. The foregoing description of the preferred embodiments of the present invention is intended to be illustrative only.

What is claimed is:

1. A compact holographic data storage system, comprising:
a volume holographic recording medium (10) for storing superimposed interference patterns;
a laser beam emitting assembly (20) having a large output area for emission of parallel laser beams with proper wavelength and cross sectional shape;
a beam splitter (50) being disposed in the optical path of parallel beams for separating out a portion of the parallel beams;
a beam steering system (60) for steering the partially separated beam as reference beam, such that the reference beam can be directed into the volume holographic recording medium (10) with a proper incident position and angle and cross sectional phase distribution; and
a spatial light modulator (40) composing of light gating components disposed in the optical path of parallel beams for holographic data input;
a photo detectors (70) as two dimensional grating format for detecting regenerated signal after the reference beam is directed to the volume holographic recording medium (10), during data read from the holographic medium (10).

2. The compact holographic data storage system as claimed in claim 1, wherein the laser beam emitting assembly (20) generates laser beams to pass through a cylindrical collimated lens and a rectangular aperture to become parallel beams with proper cross sectional shape.

3. The compact holographic data storage system as claimed in claim 1, wherein the laser beam emitting assembly (20) disposed in the center of focus area of the cylindrical collimated lens is composed of a group of laser diodes with different wavelength, and a servo mechanism for fixing laser diode with selected wavelength.

4. The compact holographic data storage system as claimed in claim 2, wherein the laser beam emitting assembly (20) disposed in the center of focus area of the cylindrical collimated lens is composed of a single laser diode that can be adjusted to different wavelength.

5. The compact holographic data storage system as claimed in claim 1, wherein the beam splitter (50) disposed in the optical path of parallel beams is composed of a reflective mirror for separating out a portion of the parallel beams in slices as reference beam to be directed to the beam steering system (60).

6. The compact holographic data storage system as claimed in claim 1, wherein the beam splitter (50) disposed in the optical path of parallel beams is composed of a narrow rectangular aperture for separating out a portion of the parallel beams in slices as reference beam to be directed to the beam steering system (60).

7. The compact holographic data storage system as claimed in claim 1, wherein the beam steering system (60) is formed by a number of reflective mirrors and a servo mechanism used for controlling the reflective angle of the mirror and the mirror position to direct the reference beam into the volume holographic recording medium (10).

8. The compact holographic data storage system as claimed in claim 1, wherein the beam steering system (60) is an opto-electronic steering device using the built-in opto-electronic mechanism to control the incident position and angle of the reference beam into the volume holographic recording medium (10).

9. The compact holographic data storage system as claimed in claim 1, wherein the beam steering system (60) further includes a phase modulator in the optical path of laser beam to modulate a reference beam with proper cross sectional phase distribution.

10. The compact holographic data storage system as claimed in claim 9, wherein the phase modulator (61) can be implemented by a fully transmissive LCD panel, such that beams can pass through different positions of the LCD panel demonstrating different phase delay characteristics.

11. The compact holographic data storage system as claimed in claim 1, wherein the spatial light modulator (40) can be implemented with a two dimensional transmissive LCD panel for controlling ON/OFF of the light gating components as parallel beams pass therethrough serving as input apparatus to the holographic recording medium.

12. The compact holographic data storage system as claimed in claim 1, wherein the spatial light modulator (40) can be implemented with a two dimensional reflective LCD panel for controlling reflection or no reflection on the light gating components as the parallel beams pass therethrough serving as an input apparatus to the holographic recording medium.

13. The compact holographic data storage system as claimed in claim 1, wherein the photo detector (70) can be implemented with a charge couple detector (CCD) camera for detecting the reconstructed beam as the reference beam enters the volume holographic recording medium (10) acting as a data readout apparatus for the holographic medium.

14. The compact holographic data storage system as claimed in claim 1, wherein the volume holographic recording medium (10) is formed by diffractive crystals made from LiNbO₃:Fe or BaTiO₃.

15. The compact holographic data storage system as claimed in claim 1, wherein the volume holographic recording medium (10) is formed by organic photo-sensitive material.
